(19) United States
(12) Patent Application Publication
(10) Pub. No.: US 2010/0326693 A1
(43) Pub. Date: Dec. 30, 2010

(54) TRANSMISSION CORD

(75) Inventors: Tang-Yin Tang, Xindian City (TW); Ching-Feng Hsieh, Taipei (TW)

Correspondence Address: EDWARDS ANGELL PALMER & DODGE LLP, P.O. BOX 55874, BOSTON, MA, 02205, US

(73) Assignee: ASKEY COMPUTER CORPORATION, Taipei (TW)

(21) Appl. No.: 12/559,621

(22) Filed: Sep. 15, 2009

(30) Foreign Application Priority Data
Jun. 30, 2009 (TW) 098121964

(51) Int. Cl. H01B 7/06

(52) U.S. Cl. 174/69

(57) ABSTRACT

A transmission cord transmits and receives electric signals. The transmission cord includes a first core pair having two conductive wires intertwined with each other, a second core pair having two conductive wires intertwined with each other, and a covering layer having a continuously winding structure collectively covering the first and second core pairs. With the first and second core pairs, both of which have two conductive wires intertwined with and insulated from each other, electrical signals transmitted and received on the transmission cord will not be coupled with or interfered by other signals. Also, with the covering layer having the continuously winding structure, a user can lengthen the transmission cord at will and have it automatically retract.

### BACKGROUND OF THE INVENTION

1. Field of the Invention

This invention relates to transmission cords, and more particularly, to a transmission cord that prevents electric signals transmitted and received thereon from being coupled with or interfered by other signals and can be shortened or lengthened at user's will.

2. Description of Related Art

With the growing popularity of network systems, a user may communicate with other users via a network system. In particular, the voice over internet protocol (VoIP) technique that exchanges data and/or voice with others via the Internet network or a network system that employs the internet protocol (IP) technique is becoming more and more popular.

A network phone uses a communication technique that uses a corresponding network system to realize real-time data and/or voice exchange. A consumer may use a network system to achieve the functions of a conventional phone. In general, the network phone is applied to a communication network inside an enterprise, and the employees in the enterprise may communicate with each other via the network phone.

A network phone has a voice receiving device, such as a handset with a microphone or a dialing pad, for receiving data and/or voice. In operation, the voice receiving device is connected via a transmission cord to a computer, predetermined software transforms data and/or voice received via the transmission cord by the voice receiving device into digital signals, and the computer transmits the digital signals via an Ethernet cable to a server of a network phone system. The above network phone is limited to be used with a computer.

Another network phone that works independently, i.e., without a computer, has come to the market. Such a network phone has a base unit directly connected to the server of the network phone system via a network cable, and a handset unit connected to the base unit via a transmission cord. As such, even without a computer, the network phone can perform phone functions. Such a network phone installs hardware needed to process signals in the base unit, and the transmission cord is used only for transmitting voice analog signals between the base unit and the handset unit and comprises four parallel core wires therein.

As network phones have become more and more popular, a simple handset unit, such as a handset unit that is typically hung on a wall, has come to the market. Such a simple handset unit differs from a conventional handset unit in that at least a part of the hardware that processes signals is installed in the handset, and a plurality of keys are integrated with the handset. Use of a curled cord would be convenient with such a handset unit, since such a cord may be conveniently expanded at will and automatically retracts, and because it has a pleasing and familiar appearance. However, in order to retain the convenience of using a curled cord, one of the most challenging problems in the art is that digital signals have to be transmitted via the curled cord. A common network cable has an eight conductor structure, and has a wire diameter so thick that the network cable cannot readily be in the shape of a curled cord and cannot be lengthened by stretching or automatically retract. Moreover, digital signals transmitted on the conventional curled cord are easily coupled with or interfered by other signals, and the quality of the digital signals are greatly impacted. In addition, the conventional curled cord cannot carry power great enough to supply the handset unit that has the hardware that processes signals.

Taiwanese Patent No. 446161 disclosed a transmission cord suitable for short-distance high-speed transmission. The transmission cord includes an even number of signal transmission wires and a plastic covering layer that covers the signal transmission wires. Each of the signal transmission wires comprises a stiff, highly pull-resistant core nylon wire and a plurality of metal conductive wires winding around the nylon wire. Although such a transmission cord provides good signal quality, it cannot be lengthened at will by a user or automatically retract.

U.S. Pat. No. 4,679,234 disclosed a coiled telephone cord connected between a handset unit and a base unit of a phone. A part of the telephone cord is coiled on a plate. Although the patent provides a curled cord that can be shortened or lengthened through the provision of the plate, electric signals transmitted on the telephone cord are still coupled with or interfered by other signals. Also, the telephone cord disclosed by the patent needs additional components and has a high manufacturing cost.

Therefore, providing a transmission cord that can carry electric signals transmitted thereon such that the electric signals will not be coupled with or interfered by other signals and such that the transmission cord can be lengthened at will and automatically retracts is an important goal in the art.

### SUMMARY OF THE INVENTION

In view of the above-mentioned problems of the prior art, the present invention provides a transmission cord that prevents electric signals transmitted thereon from being coupled with and interfered by other signals and that can be lengthened at will and automatically retracts.

In an embodiment of the present invention, the transmission cord includes: a first core pair for transmitting the electric signals, the first core pair having two conductive wires intertwined with each other; a second core pair for receiving the electric signals, the second core pair having two conductive wires intertwined with each other; and a covering layer collectively covering the first and second core pairs and having a continuously winding structure.

In another embodiment of the present invention, the transmission cord further includes two connection ports connected to both ends of the first and second core pairs, for connection of electric apparatus, such as a base unit and a handset unit of a network phone. The electric signals may be network signals, digital signals and/or power signals, and the power signals have a voltage level less than or equal to 30 volts. Each of the conductive wires has a wire diameter in the range of 26-32 AWG.

Compared with the prior art, the transmission cord according to the present invention uses the first core pair and the second core pair, both of which have two conductive wires intertwined with each other, to transmit and receive electric signals. Accordingly, the electric signals can be prevented from being coupled with or interfered by other signals. Since the transmission cord has a covering layer that has a continuously winding structure, the transmission cord can be lengthened at will and retracts automatically. Therefore, the transmission cord according to the present invention may be applied to a variety of electric apparatus, such as a base unit and a handset unit of a network phone. Moreover, the drawbacks of the prior art in which it is inconvenient to wind a network cable and electric signals transmitted on the network cable will be coupled with or interfered by other signals are both overcome.

### BRIEF DESCRIPTION OF DRAWINGS

FIG. 1 is a perspective diagram of a transmission cord of an embodiment according to the present invention;

FIG. 1A is a cross-sectional view of the transmission cord shown on FIG. 1 along line AA;

FIG. 1B is a side cross-sectional view of the transmission cord shown on FIG. 1A along line BB;

FIG. 1C is a side cross-sectional view of a transmission cord according to the present invention;

FIG. 1D is a side cross-sectional view of a transmission cord of another embodiment according to the present invention; and

FIG. 2 is a perspective diagram of the application of a transmission cord to electrical apparatus.

### DETAILED DESCRIPTION OF PREFERRED EMBODIMENTS

The following illustrative embodiments are provided to illustrate the disclosure of the present invention, these and other advantages and effects being readily understandable by those in the art after reading the disclosure of this specification. The present invention can also be performed or applied by differing embodiments. The details of the specification may be on the basis of different points and applications, and numerous modifications and variations can be devised without departing from the spirit of the present invention.

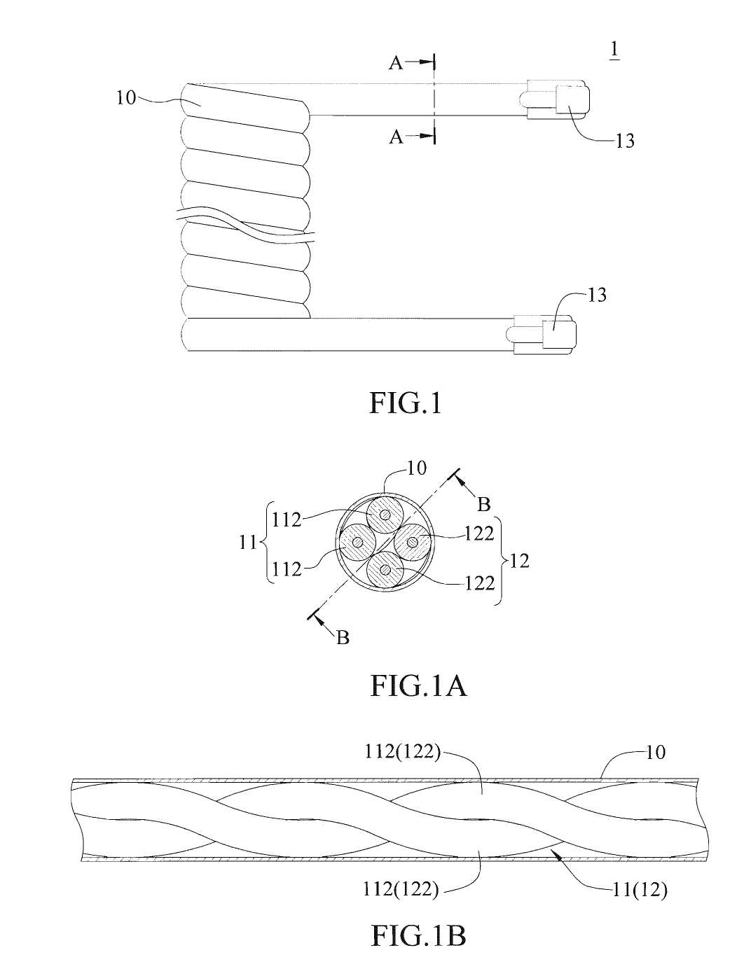

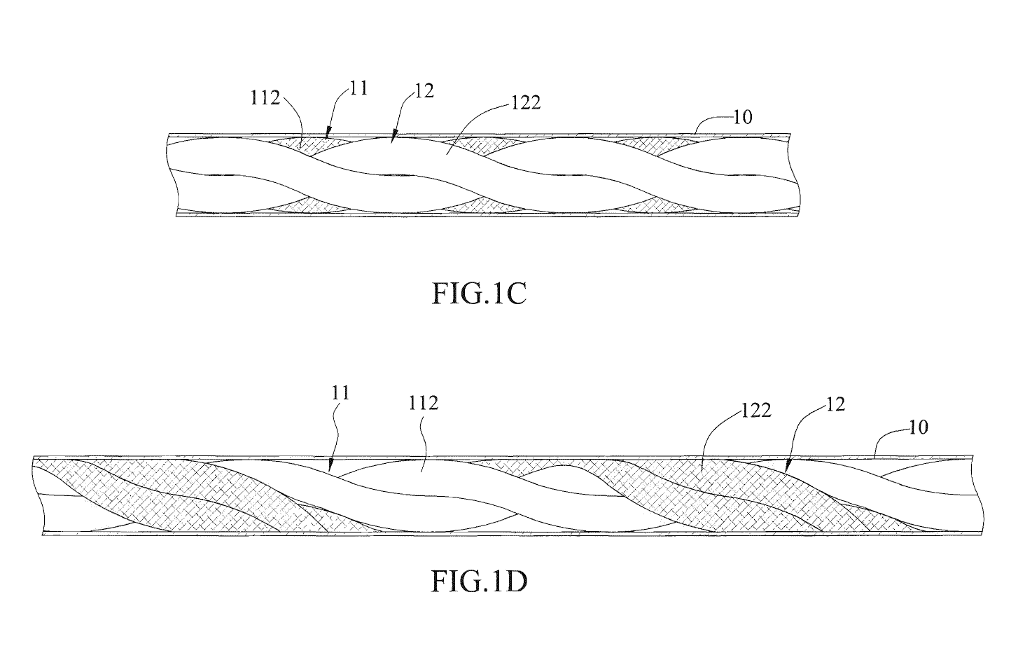

FIG. 1 is a perspective diagram of a transmission cord 1 of an embodiment according to the present invention, and FIG. 1A a cross-sectional view of the transmission cord 1 along line AA. The transmission cord 1 comprises a first core pair 11, a second core pair 12, and two connection ports 13.

The first core pair 11 comprises two intertwined conductive wires 112 and the second core pair 12 comprises two intertwined conductive wires 122, wherein the intertwining is provided to help prevent electric signals transmitted on the transmission cord 1 from being coupled with or interfered by other signals.

The covering layer 10 collectively covers the first core pair 11 and the second core pair 12 and has a continuously winding structure. In an embodiment of the present invention, the covering layer 10 is made of plastic, rubber, polychlorinated biphenyl (PCB), polyvinyl chloride (PVC), or polyethylene terephthalate (PET). Accordingly, the covering layer 10 is tough, elastic, heat-resistant, wear-resistant, and electrically insulative. The shape of the covering layer 10 is formed by winding and baking processes, and has a helical structure that can be shortened or lengthened. Through the use of the winding and baking processes, the covering layer 10 not only has elasticity, but also allows a user to adjust the length of the transmission cord 1. The transmission cord 1 is also characterized with a long lifespan and resistance to elastic fatigue.

The two connection ports 13 are connected to both ends of the first core pair 11 and the second core pair 12, for connecting electric apparatus, such as a base unit and a handset unit of a network phone. In an embodiment of the present invention, the connection ports 13 are a connection plug that has a shape similar to that of a network connection plug (e.g., the RJ-45 interface or the RJ-22 interface) that has eight positions and eight contacts (8P8C). The connection ports 13 transmit and receive electric signals, such as network signals, digital signals and/or power signals. In an embodiment of the present invention, the power signals have a voltage level less than or equal to 30 volts. In another embodiment of the present invention, the connection ports 13 are a four core connection plug (i.e., a connection plug having four positions and four contacts), and the four core connection plug is connected to the two intertwined conductive wires of the first core pair 11 and the two intertwined conductive wires of the second core pair 12. Therefore, electric signals can be output from the connection ports 13 to the electric apparatus, or received from the electric apparatus.

The conductive wires 112 of a core pair 11 and the conductive wires 122 of core pair 12 are each composed of a metal wire and an insulation layer that covers the metal wire. Accordingly, the conductive wires 112 and 122 of the first core pair 11 and the second core pair 12 are not electrically connected to each other, and are equivalent to two core pairs. In an embodiment of the present invention, the metal wire is made of a metal having good electrical conductivity, such as gold, silver, copper and aluminum, and the insulation layer is a ceramic insulator or a synthetic insulator. In operation, the traveling directions of the electrical signals on the first core pair 11 and the second core pair 12 are opposite. For example, when the first core pair 11 receives electrical signals (e.g., network signals, digital signals, or power signals) the second core pair 12 transmits electrical signals. Likewise, when the first core pair 11 transmits electrical signals, the second core pair 12 receives electrical signals. In an embodiment of the present invention, the wire diameter of the conductive wires is in the range of 26-32 American Wire Gauge (AWG).

FIG. 1B is a cross-sectional view of the transmission cord 1 shown in FIG. 1A along a line BB. The first core pair 11 and the second core pair 12 are intertwined with each other in a certain way. In an embodiment of the present invention, the first core pair 11 and the second core pair 12 are intertwined with each other clockwise. In another embodiment of the present invention, the first core pair 11 and the second core pair 12 are intertwined with each other counter clockwise.

Therefore, electromagnetic waves radiated from the first core pair 11 will be offset by electromagnetic waves radiated from the second core pair 12 when the first core pair 11 and the second core pair 12 are intertwined with each other and transmitting/receiving electrical signals. Consequently, the electrical signals transmitted/received on the transmission cord 1 will not be coupled with or interfered by other signals, maintaining good quality.

FIG. 1C is a side cross-sectional view of the transmission cord 1 according to the present invention. As shown in FIG. 1C, both the first core pair 11 and the second core pair 12 have a pair of conductive wires 112 and 122, respectively, each pair of conductive wires being intertwined and insulated from each other, and the first core pair 11 and the second core pair 12 are parallel. Further, the covering layer 10 collectively covers the first core pair 11 and the second core pair 12.

Please refer to FIG. 1D, which is a side cross-sectional view of a transmission cord of another embodiment according to the present invention. The first core pair 11 and the second core pair 12 are intertwined with each other, rather than being parallel. In this way, the covering layer 10 tightly covers the first core pair 11 and the second core pair 12, and the transmission cord has a reduced wire diameter.

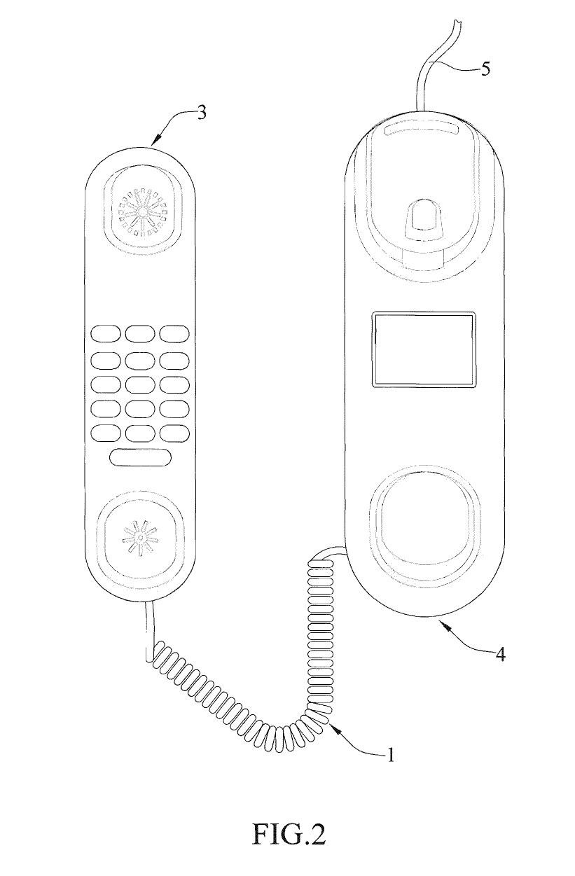

FIG. 2 is a perspective diagram of the application of a transmission cord to electrical apparatus. As shown in FIG. 2, the transmission cord 1 is applied between a handset unit 3 and a base unit 4 of a network phone, and the base unit 4 is further connected via a network wire 5 to a server of a network phone system.

In an embodiment of the present invention wherein the network wire 5 is an Ethernet cable, when a calling party uses the handset unit 3 and the base unit 4 to communicate with a called party, a calling end transmits network signals to the base unit 4 of the network phone via the network wire 5, and then the base unit 4 of the network phone captures power signals and digital signals from the network signals, bridges and amplifies the digital signals, adjusts the voltage level of the power signals, feeds the adjusted power signals into the digital signals to form integrated signals, and transmits the integrated signals to the handset unit 3 of the network phone. At the same time, the handset unit 3 of the network phone captures the power signals from the integrated signals to supply the handset unit 3 with the power signals, and captures the digital signals from the integrated signals and transforms the digital signals into analog signals (e.g., sound), for identification or reception of the called party (not shown). The called party communications apparatus transforms the user's analog sound signals into digital signals and transmits the transformed digital signals to the calling party to communicate with the calling party.

In an embodiment of the present invention, the base unit 4 of the network phone can also communicate with the server of the network phone system via a wireless network connection technique (e.g., Wi-fi, Wi-MAX).

In conclusion, the transmission cord according to the present invention uses the first core pair and the second core pair to transmit and receive electric signals, and uses the connection ports to connect electrical apparatus (e.g., a base unit and a handset unit of a network phone). With the first core pair and the second core pair, both of which have two conductive wires intertwined with each other, the electrical signals transmitted or received on the transmission cord will not be coupled with or interfered by other signals. In addition, since the covering layer of the transmission cord collectively covers the first and second core pairs and has a continuously winding structure, the transmission cord can be lengthened at will and automatically retracts.

The foregoing descriptions of the detailed embodiments are illustrated to disclose the features and functions of the present invention and are not intended to be restrictive of the scope of the present invention. It should be understood by those in the art that many modifications and variations can be made according to the spirit and principles in the disclosure of the present invention and yet fall within the scope of the appended claims.

What is claimed is:

1. A transmission cord applicable to transmitting and receiving electrical signals and preventing the electrical signals from being coupled with or interfered by other signals, the transmission cord comprising:
a first core pair for transmitting the electrical signals, the first core pair having two conductive wires intertwined with each other;
a second core pair for receiving the electrical signals, the second core pair having two conductive wires intertwined with each other; and
a covering layer collectively covering the first and second core pairs and having a continuously winding structure.

2. The transmission cord of claim 1, further comprising two connection ports connected to both ends of the first and second core pairs for connection of electrical apparatus.

3. The transmission cord of claim 2, wherein the connection ports comprise a four core connection port.

4. The transmission cord of claim 2, wherein the electrical apparatus comprises a base unit and a handset unit of a network phone.

5. The transmission cord of claim 1, wherein the electrical signals comprise at least one selected from the group consisting of network signals, digital signals and electrical power.

6. The transmission cord of claim 5, wherein the electrical power has a voltage level less than or equal to 30 volts.

7. The transmission cord of claim 1, wherein the covering layer is made of plastic.

8. The transmission cord of claim 1, wherein the covering layer is manufactured to have the continuously winding structure by a winding process and a shape-forming baking process.

9. The transmission cord of claim 1, wherein the conductive wires have a wire diameter in the range of 26-32 American Wire Gauge (AWG).

10. The transmission cord of claim 1, wherein the conductive wires comprise metal wires with insulation layers covering the metal wires.

11. The transmission cord of claim 1, wherein the continuously winding structure is in a helical shape.

12. The transmission cord of claim 1, wherein the first and second core pairs are intertwined with each other.

13. The transmission cord of claim 1, wherein the first and second core pairs are parallel to each other.
